(19) United States
(12) Patent Application Publication
(10) Pub. No.: US 2023/0225566 A1
(43) Pub. Date: Jul. 20, 2023

(54) PORTABLE SHOWER STATION AND METHODS OF USE

(71) Applicant: SPEAKMAN COMPANY, Glen Mills, PA (US)

(72) Inventor: Christopher G. Miedzius, Newark, DE (US)

(73) Assignee: SPEAKMAN COMPANY, Glen Mills, PA (US)

(21) Appl. No.: 17/580,432

(22) Filed: Jan. 20, 2022

(51) Int. Cl. A47K 3/28; B05B 1/20; B05B 15/658

(52) U.S. Cl. CPC A47K 3/28; B05B 1/20; B05B 15/658

(57) ABSTRACT

Portable decontamination shower stations for connection to an external source of water are disclosed. The portable shower stations have a shower stall frame constructed of plastic or stainless steel tubing or piping with vertical tubes connected to a top frame by hose coupling or a combination of hinges and hose couplings, which allow for rapid and easy disassembly, storage, and transport. The vertical tubes generally have a tripod configuration for increased stability and contain a plurality of spray nozzles positioned along their lengths to provide a 360-degree spray coverage to an individual in need of decontamination. Also provided herein are methods of use and of assembly and disassembly of the portable shower stations.

### FIELD OF THE INVENTION

The present invention generally relates to portable decontamination showers and methods of use. Specifically, the invention relates to portable shower stations capable of rapid assembly and connection to a source of pressurized water for on-sight hazardous substance decontamination of individuals in need of such decontamination.

### BACKGROUND OF THE INVENTION

First responders, such as firemen, hazmat crews, medical personnel, and others are often exposed to hazardous substances while performing their duties, whether it be cleaning up a toxic spill, dealing with triage during a pandemic, or putting out a chemical fire. To protect against or reduce the deleterious consequences of such exposure, it is often necessary to rapidly decontaminate individuals who have been exposed to hazardous substances while performing their duties. A known approach to decontamination of individuals exposed to hazardous substances is vigorous showering in order to drive out the contaminants present on the individual's clothing and skin.

While decontamination showers are present in many health care and research facilities, a need remains in the art for portable decontamination systems that can be transported to a location where individuals are at risk for exposure to hazardous substances. Such portable shower stations must be easily moved to the needed location and be adapted to connect to an existing source of water under pressure. Existing portable shower stations are lacking in several aspects. First, such portable shower stations may only have one or two showerheads for decontamination thus requiring longer decontamination times. As such, these shower stations are insufficient for situations where a large number of individuals are exposed to hazardous substances simultaneously (e.g., large chemical fire, biological spill, and the like), which would require shorter decontamination times to achieve large scale decontamination. Therefore, there is a need for portable decontamination shower stations with more efficient decontamination sprays to ensure that decontamination is immediately available to a larger number of individuals.

Other portable shower stations are designed to flow pressurized water through its frame to various spray nozzles and provide large spray coverage area, which shortens the time needed for decontamination. However, due to the flow of pressurized water throughout the structure, these portable shower station designs tend to be less stable and are prone to rocking and tipping. While increasing the weight and size of the portable shower station structure improves stability, the increased weight and size renders these portable shower stations less practical for transporting to a remote location. Moreover, in an emergency situation, the user must be able to quickly and easily transport the portable shower stations to the needed location and rapidly assemble the shower station without the need for specialized tools or expertise.

Thus, there remains a need in the art for portable shower stations that are easily transported and rapidly assembled without sacrificing structural stability or decontamination spray coverage.

### SUMMARY OF THE INVENTION

Described herein are portable shower stations that are intended to overcome the shortcomings of currently known systems, and which will enable decontamination on a large scale at any location where a nearby source of water or other decontamination liquid is present. The novel and innovative designs of the instant portable shower stations enable quick assembly and disassembly to enable ease of storage and transport of the portable shower stations on sight. Furthermore, the designs disclosed herein provide for increased stability of the structure without sacrificing spray coverage or flow rate.

One aspect of the invention features a portable shower station for connection to a supply of water under pressure, which includes a base frame, a top frame, and a plurality of angled vertical tubes. Moreover, each angled vertical tube is connected to and upstanding from the base frame, and connected to the base frame by a first connection member. Further, each angled vertical tube is connected to the top frame by a second connection member. The angled vertical tubes and the top frame cooperatively define a shower stall. A water supply inlet is located on at least one of the angled vertical tubes for connecting the portable shower station to a supply of water under pressure. There is also a valve member for enabling the flow of water through the angled vertical tubes and the top frame. Finally, each angled vertical tube comprises at least one spray nozzle for spraying a portion of the water into the shower stall.

In another embodiment, each angled vertical tube of the portable shower station is a multicomponent angled vertical tube comprising a lower tube section that is connected to the base frame by the first connection member, and an upper tube section that is connected to the top frame by the second connection member, wherein each upper tube section comprises a lower end that is vertically connected to an upper end of the lower tube section by a third connection member. In yet another embodiment, there are at least three angled vertical tubes. In some aspects, each angled vertical tube comprises at least two spray nozzles for spraying a portion of the water in the shower stall, wherein each spray nozzle provides a spray cone coverage of at least about 60 degrees. In others, there are at least three spray nozzles on each angled vertical tube for spraying a portion of the water in the shower stall, wherein each spray nozzle provides a spray cone coverage of at least about 60 degrees, and wherein the spray nozzles cooperatively provide a total spray coverage of about 360 degrees.

In addition, the base frame may be a multicomponent base frame comprising a plurality of base tube sections, each of which is connected to two of the angled vertical tubes by the first connection members. In some designs, the multicomponent base frame comprises at least three base tube sections, each of which is connected to two of the lower tube sections by the first connection members. In some embodiments, each of the second connection members and the third connection members is a hose coupling, such as a cam and groove coupling.

In another embodiment, the base frame has a circumcircle diameter of at least about 5 feet and/or the shower stall has a height of at least about 7 feet. Each angled vertical tube may comprise along its length at least one bend angle at least about 20 degrees such that the top of the shower stall is tapered relative to the bottom of the shower stall. In yet another embodiment, the first connection member is a button spring locking pin or a spring loaded pin. In yet others, the first connection members and the second connection members enable connection and disconnection of the angled vertical tubes from the top frame and base frame. Further, the third connection members may enable connection and disconnection of the upper tube section and lower tube section of each multicomponent angled vertical tube.

In some aspects, each of the angled vertical tubes, top frame, and base frame comprises polyvinyl chloride or stainless steel. For instance, each of the angled vertical tubes, top frame, and base frame may comprise polyvinyl chloride with a total weight of less than about 30 pounds. In another embodiment, one of the angled vertical tubes further comprises an outlet on one of the lower tube sections for connection to a second decontamination device, such as, but not limited to, an eyewash or spray hose.

Another aspect of the invention features a portable shower station that includes (a) a multicomponent base frame comprising a plurality of base tube sections, wherein each base tube section comprises a first connection member at each end; (b) a top frame comprising a plurality of arm portions extending laterally from a central point, wherein each arm portion comprises a first portion of a hose coupling; and (c) three multicomponent angled vertical tubes. Furthermore, each of the multicomponent angled vertical tubes includes at least one spray nozzle, an upper tube section comprising a top end with a second portion of a hose coupling, and a bottom end with a third portion of a hose coupling, and a lower tube section with a top end comprising a fourth portion of a hose coupling, and a bottom end having two second connection members. Additionally, one of the multicomponent vertical tubes includes an inlet valve and water supply inlet for connecting the portable shower station to a supply of water under pressure. In this aspect, water flows through the multicomponent angled vertical tubes and the top frame when the water supply inlet is connected to the supply of water under pressure.

In one embodiment, each multicomponent angled vertical tubes comprises three spray nozzles configured to spray a portion of the water under pressure into the shower stall when the water supply inlet is connected to the supply of water under pressure. In another embodiment, the first portion of the hose coupling of each arm portion of the top frame is coupled to the second portion of the hose coupling of an upper tube section, the third portion of the hose coupling of each upper tube section is coupled to the fourth portion of the hose coupling of a lower tube section, and the first connection members of each base tube section is connected to a second connection element of a lower tube section. As such, the lower tube sections, the upper tube sections, the top frame, and the base tube sections form a shower stall.

In yet another embodiment, each multicomponent angled vertical tube comprises an elbow having a bend angle of about 15 degrees to about 30 degrees. In others, the hose coupling is a cam and groove hose coupling, and the first connection member and the connection member are connected by a push button spring locking pin or a spring loaded pin. In some examples, the shower stall has a height of at least about 7 feet and the multicomponent base frame has a circumcircle diameter of at least about 5 feet.

In one embodiment, the portable shower station described above is further connected to a source of water under pressure. In another, one of the multicomponent angled vertical tubes further comprises an outlet on one of the lower tube sections for connection to an eyewash station or a spray hose.

Another aspect of the invention features a method of decontaminating an individual in need of decontamination, where the individual is within the shower stall of the portable shower station as described above and exposed to a decontamination water spray for a period of time of at least about 30 seconds.

The invention described herein also features a method of decontaminating an individual in need thereof, which incorporates a portable shower station that has a multicomponent base frame that includes a plurality of base tube sections, with each base tube section having a first connection member at each end. The portable shower station further includes a top frame with a plurality of arm portions extending laterally from a central point, where each arm portion comprises a first portion of a hose coupling. There are also a plurality of multicomponent angled vertical tubes, each of which includes at least one spray nozzle. Each multicomponent angled vertical tube includes an (i) upper tube section with a top end having a second portion of a hose coupling and a bottom end with a third portion of a hose coupling; and (ii) a lower tube section with a top end having a fourth portion of a hose coupling and a bottom end with two second connection members. Furthermore, one of the multicomponent vertical tubes includes a water supply inlet and an inlet valve.

The method includes the steps of a) providing an individual in need of decontamination; b) providing the portable shower station; c) assembling the portable shower station, which assembly includes coupling the first portion of the hose coupling of each arm portion of the top frame to the second portion of the hose coupling of an upper tube section, coupling the third portion of the hose coupling of each upper tube section to the fourth portion of the hose coupling of a lower tube section, and connecting each first connection element of each base tube section to a second connection element on a lower tube section to form a shower stall; d) connecting the water supply inlet to an external source of water under pressure; and e) opening the inlet valve such that the water under pressure flows through each of the lower tube sections, the upper tube sections, and the top frame, and exits the plurality of spray nozzles to produce a decontamination water spray to the individual when the individual is within the shower stall.

In some embodiments of the method, the individual in need of decontamination is exposed to the decontamination water spray for at least about 30 seconds. In other embodiments, the individual in need of decontamination has been exposed to a hazardous substance, such as, but not limited to, a chemical, biological contaminate, radioactive substance, or any combination thereof. In yet other embodiments, the method includes the step of disassembling the portable shower station. For instance, in one embodiment, the method includes the step of uncoupling the hose couplings and disconnecting the first and second connection elements.

Another aspect of the invention features a collapsible portable shower station for connection to a supply of water under pressure. In this aspect, the portable shower station includes a top frame with a plurality of arm portions extending laterally from a central point, and where each arm portion includes a first portion of a hose coupling. This portable shower head design includes a plurality of multicomponent vertical tubes, each of which includes (a) at least one spray nozzle; (b) an upper tube section with a top end having a second portion of a hose coupling and a bottom end with a third portion of a hose coupling, and where each upper tube section is connected to an arm portion of the top frame by a first hinge member; and (c) a lower tube section having a top end with a fourth portion of a hose coupling, and where each lower tube section is connected to an upper tube section by a second hinge member. In addition, one of the multicomponent vertical tubes includes a water supply inlet and an inlet valve. This version of the portable shower station is convertible between an extended configuration and a folded configuration, where the top frame and the multicomponent angled vertical tubes form a shower stall when in an extended configuration. Each spray nozzle is configured to spray a portion of water when the water supply inlet is connected to an external source of water under pressure. In one embodiment, the first hinge element, the second hinge element, or both is a plate hinge or a pivot hinge to enable a user to: (i) extend each lower tube section in relation to the upper tube sections to which it is hingedly attached, and (ii) further extend each upper tube section in relation to the arm portion of the top frame to which it is hingedly attached to convert the portable shower station to the extended configuration. The user is also enabled to fold each lower tube section inward in relation to the upper tube section to which it is hingedly attached and further fold each upper tube section inward in relation to the arm portion of the top frame to which it is hingedly attached to convert the portable shower station to the folded configuration.

In another embodiment, the first portion of the hose coupling of each arm portion of the top frame is coupled to the second portion of the hose coupling of each upper tube section to which it is hingedly attached when the portable shower station is in the extended configuration. In yet another embodiment, the third portion of the hose coupling of each upper tube section is coupled to the fourth portion of the hose coupling of each lower tube section to which it is hingedly attached when the portable shower station is in the extended configuration. In still other embodiments, the hose coupling is a nonthreaded hose coupling, such as, but not limited to, a cam and groove hose coupling.

In one embodiment, each multicomponent angled vertical tube comprises at least two spray nozzles for spraying a portion of the water in the shower stall, wherein each spray nozzle provides a spray cone coverage of at least about 60 degrees. In another, each multicomponent angled vertical tube comprises at least three spray nozzles for spraying a portion of the water in the shower stall, wherein each spray nozzle provides a spray cone coverage of at least about 60 degrees. In still another embodiment, each multicomponent angled vertical tube comprises at least four spray nozzles for spraying a portion of the water in the shower stall, wherein each spray nozzle provides a spray cone coverage of at least about 60 degrees. In some embodiments, the spray nozzles cooperatively provide a 360-degree spray coverage to the individual when in the shower stall.

In another aspect, each lower tube section has a flange at a bottom end that is disposed on a surface when the portable shower station is in the extended configuration, and wherein each flange comprises at least one hole for placement of a bolt or peg to stabilize the portable shower station. In another embodiment, the shower stall has a height of at least about 7 feet. In one embodiment, the portable shower station has a shower stall base when the flanges are disposed on a surface and when the portable shower station is in the extended configuration. In such embodiment, the shower stall base has a circumcircle diameter of at least about 5 feet. In yet another embodiment, each multicomponent angled vertical tube comprises along its length at least one bend angle, such as a bend angle of about 15 to about 30 degrees to taper the top of the shower stall relative to the bottom of the shower stall.

In another embodiment, each of the multicomponent angled vertical tubes and top frame comprises polyvinyl chloride or stainless steel. In yet another embodiment, each of the multicomponent angled vertical tubes and top frame comprises stainless steel with a total weight of less than about 60 pounds. In some designs, one of the multicomponent angled vertical tubes further comprises an outlet on one of the lower tube sections for connection to a second decontamination device, such as, but not limited to, an eyewash or spray hose.

Another aspect of the invention features a method of decontaminating an individual in need thereof that includes the steps of a) providing an individual in need of decontamination; b) providing the collapsible portable shower station described above; c) extending the portable shower station by extending each upper tube section in relation to the arm portion of the top frame to which it is hingedly attached, coupling the first portion of the hose coupling of each arm portion of the top frame to the second portion of the hose coupling of each upper tube section to which it is hingedly attached, extending each lower tube section in relation to the upper tube section to which it is hingedly attached, and coupling third portion of the hose coupling of each upper tube section to the fourth portion of the hose coupling of each lower tube section to which it is hingedly attached; d) disposing the portable shower station on a surface; e) connecting the water supply inlet to an external source of water under pressure; and f) opening the inlet valve whereby the water under pressure flows through each of the lower tube sections, the upper tube sections, and the top frame, and exits the plurality of spray nozzles to produce a decontamination water spray to the individual when the individual is in the shower stall.

In one embodiment, the individual in need of decontamination is exposed to the decontamination water spray for at least about 30 seconds. In another embodiment, the individual in need of decontamination has been exposed to a hazardous substance, such as, but not limited to, a chemical, biological contaminate, radioactive substance, and any combination thereof. The method may also include the additional step of converting the portable shower station to the folded configuration by uncoupling the hose couplings and folding each lower tube section inwards in relation to the upper tube section to which it is hingedly attached and folding each upper tube section inwards in relation to the arm portion of the top frame to which it is hingedly attached.

Other features and advantages of the invention will be apparent by reference to the drawings, detailed description, and examples that follow.

### BRIEF DESCRIPTION OF THE DRAWINGS

FIG. 1 is a perspective view of an embodiment of a quick-assembly portable shower station.

FIG. 2 is a bottom view of an embodiment of a quick-assembly portable shower station.

FIG. 3 is an exploded view of an embodiment of a disassembled portable shower station.

FIG. 4A depicts front perspective views of the cam and groove hose coupling components.

FIG. 4B is a cross section of the cam and groove hose coupling components.

FIG. 5A is a perspective view of the tee-section and spray nozzle assembly for use in an embodiment of the portable shower station.

FIG. 5B depicts a front perspective view (left) and a cross-section diagram (right) of a spray nozzle for use in an embodiment of the portable shower station.

FIG. 5C depicts a front perspective view (left) and a cross-section diagram (right) of a bushing reducer for use in an embodiment of the portable shower station.

FIG. 6 is a perspective view of an embodiment of a quick-assembly portable shower station.

FIG. 7A is a cross-section of the optional outlet of a quick-assembly portable shower station.

FIG. 7B is a front perspective view of an exemplary connection mechanism between a multicomponent angled vertical tube and two corresponding multicomponent base sections.

FIG. 7C is an exploded view of an exemplary connection mechanism between a multicomponent angled vertical tube and two corresponding multicomponent base sections. The spring loaded pins are shown.

FIG. 7D is a cross section of an exemplary connection mechanism between a multicomponent angled vertical tube and two corresponding multicomponent base sections. The spring loaded pin is visible.

FIG. 8 is a perspective view of an embodiment of a collapsible portable shower station.

FIG. 9A is a bottom view of an embodiment of a collapsible portable shower station.

FIG. 9B is a top view of an embodiment of a collapsible portable shower station.

FIG. 10 is an exploded view of an embodiment of a collapsible portable shower station.

FIG. 11 is an embodiment of a portable shower station that is folded for storage.

FIG. 12 are diagrams depicting an individual standing within the shower stall portion of an embodiment of the collapsible portable shower station. Shown are the side view (Panel A), top view (Panel B), and perspective view (Panel C).

FIG. 13 is a computer model of the 360-degree spray pattern of an embodiment of a collapsible portable shower station.

### DETAILED DESCRIPTION OF THE INVENTION

The portable shower stations described herein have a novel and innovative design that includes a plurality of angled vertical tubes connected to a top frame and, optionally a bottom frame. The top frame itself comprises a plurality of tubes that are coupled to the vertical tubes and, together with the vertical tubes, form a shower stall frame that flows pressurized water through a plurality of spay nozzles positioned at various points along the length of the vertical tubes. In this manner, the portable shower stations described herein provide for 360-degree spay coverage to a user standing in the shower stall, thus increasing decontamination efficiency. The portable shower stations preferably are made from rigid plastic or stainless steel piping and tubing to ensure lighter weight for ease of transport and handling. Furthermore, in preferred embodiments, the portable shower stations disclosed herein have a tripod design that increases stability of the structure even as water flows through the tubing of the structure, making the instant portable shower stations ideal for on-sight assembly and use at locations where decontamination is needed.

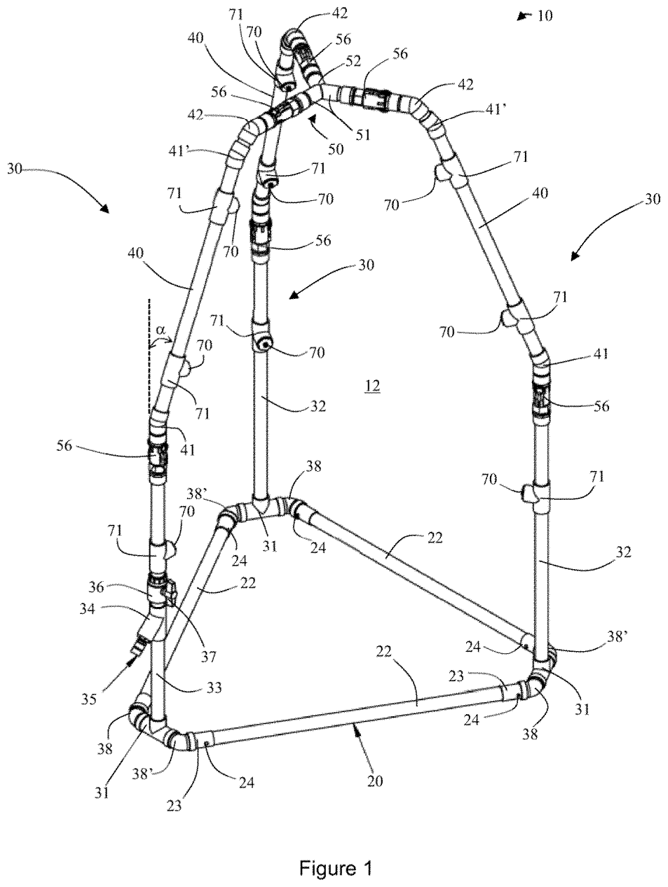

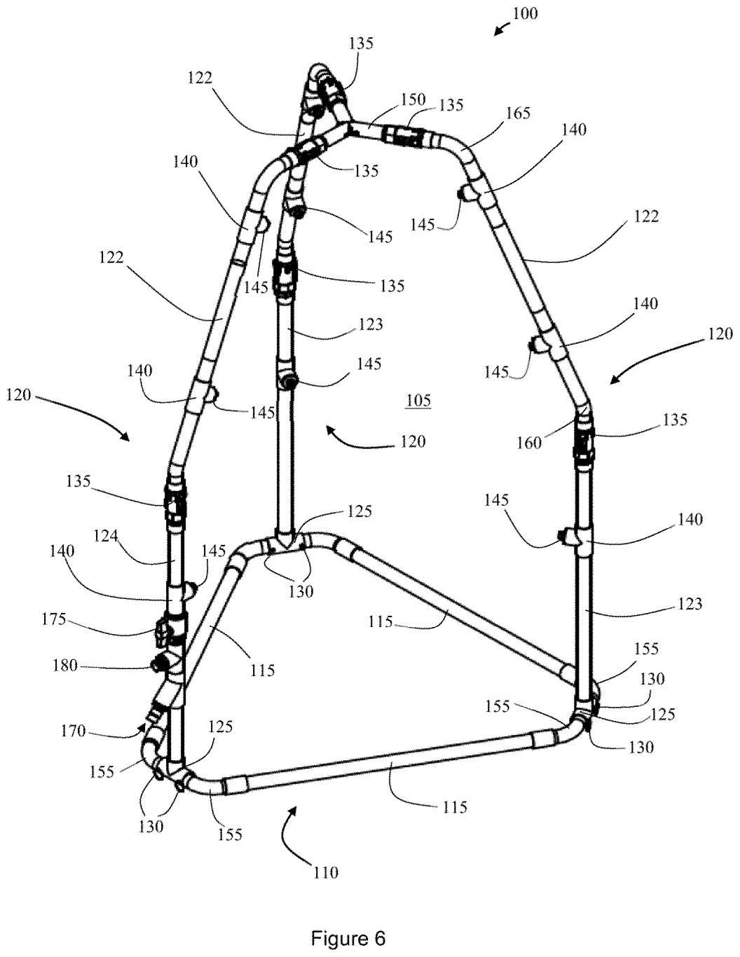

In one embodiment, a quick-assembly portable shower station is disclosed, which is designed to be assembled on-sight from a plurality of components that can be coupled via nonthreaded hose couplings enabling rapid assembly while maintaining fluid communication of the vertical tubes and top frame when connected to an external source of water under pressure. After use, the nonthreaded hose couplings enable rapid disassembly of the portable shower station for ease of transport and storage. Exemplary embodiments of the quick-assembly portable shower station are depicted in FIGS. 1 and 6.

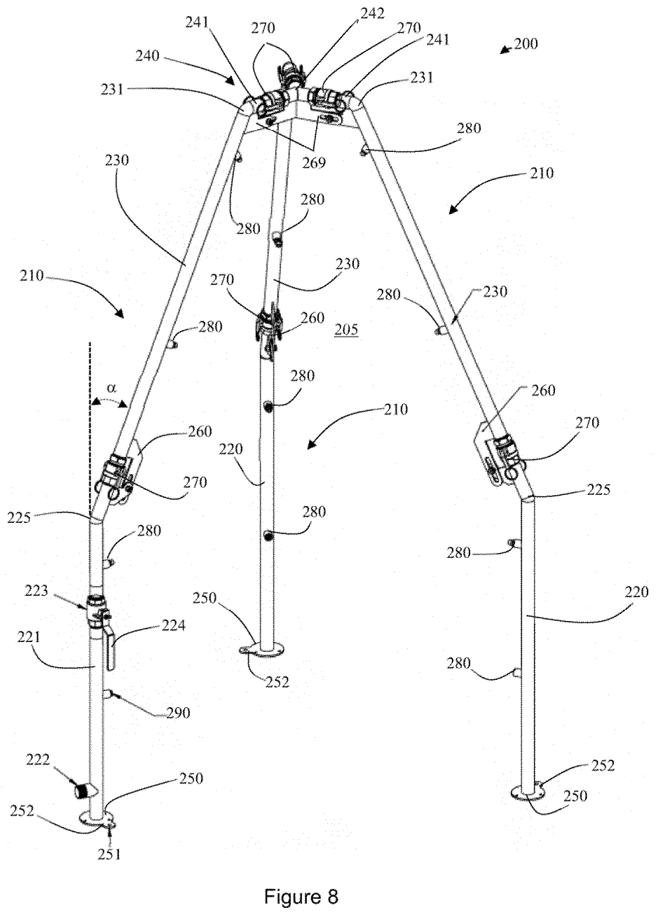

In another embodiment, a collapsible portable shower station is disclosed whereby the portable shower station components are attached by way of a combination of hinge mechanisms and nonthreaded hose couplings to allow for rapid extension and assembly of the portable shower station on sight. After use, rather than be taken apart, the nonthreaded hose coupling and hinge combination allows the user to fold or collapse the portable shower station for ease of transport and storage. An exemplary embodiment of the collapsible portable shower station is depicted in FIG. 8.

Thus, the present invention proposes an improved system of decontamination that will enable decontamination shower stations to be transported to, and rapidly set up at, any location with an external source of water under pressure to provide a system for decontamination of hazardous substances on a large scale to first responders in need of such decontamination. Moreover, the inclusion of spay nozzles at various positions along the length of the vertical tube frame of the portable shower stations provides 360-degree spray coverage for more efficient decontamination and reduction in decontamination times as compared to existing devices with a single shower head. Finally, the vertical tube shower stall design provides increased stability of the structure that enables flow through of pressurized water without destabilizing the portable shower station when in use.

Unless defined otherwise, all technical and scientific terms used herein have the same meaning as those commonly understood by one of ordinary skill in the art to which this invention belongs. Standard techniques are used unless otherwise specified. Although methods and materials similar or equivalent to those described herein can be used in the practice or testing of the present disclosure, suitable methods and materials are described below. The materials, methods and examples are illustrative only, and are not intended to be limiting. All publications, patents and other documents mentioned herein are incorporated by reference in their entirety.

Ranges, if used, are used as shorthand to avoid having to list and describe each and every value within the range. Any value within the range can be selected, where appropriate, as the upper value, lower value, or the terminus of the range.

As used herein, the singular forms “a,” “an,” and “the” include the plural referents unless the context clearly indicates otherwise. Likewise, the terms “include”, “including”, and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “about” refers to the variation in the numerical value of a measurement, e.g., diameter, weight, length, volume, angle degrees, etc., due to typical error rates of the device used to obtain that measure. In one embodiment, the term “about” means within 5% of the reported numerical value, preferably, the term “about” means within 3% of the reported numerical value.

The term “comprising” is intended to include embodiments encompassed by the terms “consisting essentially of” and “consisting of.” Similarly, the term “consisting essentially of” is intended to include embodiments encompassed by the term “consisting of.”

The term “circumcircle” as used herein refers to a circle that passes through all of the vertices of a cyclic polygon. The “circumcircle diameter” is the diameter of the circumcircle.

The term “substantially” as used herein to refer to lateral or perpendicular means within 5 degrees of the lateral or perpendicular orientation; preferably, within 3 degrees of the lateral or perpendicular orientation. The term “substantially dry” as used herein to a base frame means that, in the absence of a leak or defect, the water flowing through the tubes or piping of the base frame is less than 0.5 psi; preferably, less than 0.25 psi; more preferably, about 0 psi.

The portable shower stations described herein are designed to enable rapid and easy on-sight assembly and to provide 360-degree spray coverage to an individual in need of decontamination or emergency showering. The portable shower stations disclosed herein will preferably be constructed of relatively lightweight yet rigid and durable material, such as, but not limited to, rigid plastics (e.g., polyvinyl chloride (PVC)) or stainless steel. As such, the total weight of the portable shower station is less than about 60 pounds. Preferably, the portable shower station comprises stainless steel with a total weight of less than about 60 pounds, or the portable shower station comprises PVC pipe with a total weight of less than about 30 pounds. Furthermore, the instant designs allow for rapid disassembly or collapsibility/folding to allow health care workers, first responders, hazardous waste clean-up personnel, and others to easily store and transport the portable shower stations and quickly assemble them at the location in which they are needed.

The preferred embodiments of the portable shower stations utilize a unique tripod vertical tube design that provides enhanced stability over other portable shower stations existing in the art without sacrificing the spray coverage needed to ensure adequate decontamination and cleaning. Once assembled for operation, the user need only a hose or other fluid conveyance device in fluid communication with a supply of water under pressure for connection to the portable shower stations provided herein. In some embodiments, the portable shower stations of the disclosure include additional/optional outlet attachments for connection to a portable eyewash station or spray hose attachment, if desired. For instance, a spray hose attachment may include a manual sprayer nozzle for localized spraying for hard-to-reach parts, such as the boots or boot bottoms, underarms, crotch area, and the like. The spray hose attachment may also include a container that enables liquid decontamination products to be mixed with the water as it exits the nozzle. The portable shower stations provided herein preferably will comply with standard ISEA/ANSI 113 (decontamination showers) and, if a portable eyewash station is connected, ISEA/ANSI Z358.1.

While alternative designs are contemplated, it is preferred that each of the portable shower station designs disclosed herein have a tripod arrangement of tubes or pipes for flowing water under pressure and forming the vertical structure or frame of the shower stall. It is also preferred that the shower stall structure tapers towards the top portion of the shower stall. Since the shower stalls of the portable shower stations are constructed of tubing or piping, spray nozzles can be positioned along the length of the vertical frame of the shower stall to provide enhanced decontamination spray coverage to the individual user in need of decontamination. Moreover, there is less extraneous structural material thus keeping the weight low and minimizing the space needed for transport and storage. In general, the portable shower stations will have at least one tube or pipe that spans the height of the shower station and includes a plurality of spray nozzles along its length. In preferred embodiments, all tubes or pipes that form the frame of the shower station (with the exception of the base frame, if present) will flow water under pressure. In one embodiment, the tubes or pipes that form the frame of the shower station are predominantly 1 in. to 1¼ in. tubing or piping (e.g., stainless steel or PVC tubing or piping).

In general, the portable shower station designs disclosed herein will have a top frame and at least one vertical tube that flows water under pressure. For instance, in some embodiments, there are two or more vertical tubes that are connected to a top frame and flow water under pressure. In a preferred embodiment, the portable shower station will have a top frame in fluid communication with at least three vertical tubes capable of flowing water under pressure, with each of these vertical tubes populated with spray nozzles. In particularly preferred designs, the three vertical tubes are arranged in a tripod configuration to provide added structural stability when connected to a source of water under pressure. The top frame and vertical tubes form the shower stall, in which the user will stand in order to receive pressurized spray coverage for decontamination and emergency cleansing. In some versions of the invention, the portable shower station will include a base frame. Preferably, the base frame is also constructed of tubing or piping, but will be a substantially dry base. In other words, the frame of the portable shower station will have plugs or other blockages to prevent water from flowing through the base frame.

The portable shower station will preferably be in a disassembled or collapsed configuration when not in use, but capable of rapid assembly or extension when it is desired to provide a decontamination shower. In one embodiment, the portable shower station is disassembled when not in use, and may comprise a top frame, at least three angled vertical tubes, and a base frame, which can be rapidly assembled by way of coupling or connection elements into a portable shower stall when decontamination is needed. In another embodiment, the portable shower station is collapsed or folded when not in use, and comprises a top frame and at least three vertical angled tubes, which can be rapidly extended and fixed into place by way of a series of hinges and/or coupling elements.

In some aspects, the vertical angled tubes themselves may be capable of folding or disassembly to reduce the space required for storage. For instance, each vertical tube may comprise a lower tube section and an upper tube section that are connected by a hinge element and/or a coupling element to enable the lower tube section and upper tube section to be easily assembled/disassembled or folded for transport and storage. Moreover, each of upper tube sections will have an additional hinge element and/or coupling element at the opposite end of the lower tube section connection for connection to the top frame for easy assembly/disassembly or folding. Each vertical tube will also have an elbow joint or bend located at about the middle third of the total length of the vertical tube; preferably, the shower stall includes three such vertical tubes in a tripod configuration to provide enhanced stability. This elbow joint or bend may be constructed from standard angled tubes or custom-bent tubing and located on the lower tube section or the upper tube section near the hinge element and/or coupling element. The elbow joint or bend will have a bend angle of about 15 degrees to about 30 degrees from vertical, e.g., 15, 16, 17, 18, 19, 20, 21, 22, 23, 24, 25, 26, 27, 28, 29, or 30 degrees from vertical (see, for example, FIG. 1, FIG. 6, and FIG. 8). In a preferred embodiment, the bend angle is about 20 degrees to 25 degrees from vertical. In one particular embodiment, the elbow joint or bend has a bend angle of about 22.5 degrees from vertical or about 25 degrees from vertical.

To ensure use by the vast majority of body types, the shower stalls of the portable shower stations provided herein will have a height ranging from about 6 feet to about 8 feet, e.g., 72 in., 73 in., 74 in., 75 in., 76 in., 77 in., 78 in., 79 in., 80 in., 81 in., 82 in., 83 in., 84 in., 85 in., 86 in., 87 in., 88 in., 89 in., 90 in., 91 in., 92 in., 93 in., 94 in., 95 in., or 96 in; preferably, the shower stall height is between about 80 in. to about 90 in. (i.e., at least about 6 feet 8 inches or more in height). As noted above, each of the vertical tubes forming the sidewalls of the shower stall include a lower tube section and an upper tube section. The length of each of the lower tube sections ranges from about 40 in. to about 60 in., e.g., 41 in., 42 in., 43 in., 44 in., 45 in., 46 in., 47 in., 48 in., 49 in., 50 in., 51 in., 52 in., 53 in., 54 in., 55 in., 56 in., 57 in., 58 in., 59 in., or 60 in. The length of each of the upper tube sections ranges from about 40 in. to about 60 in., e.g., 41 in., 42 in., 43 in., 44 in., 45 in., 46 in., 47 in., 48 in., 49 in., 50 in., 51 in., 52 in., 53 in., 54 in., 55 in., 56 in., 57 in., 58 in., 59 in., or 60 in.

Optionally, the portable station will have a base frame that is connected to the lower tube sections by way of a connection element for ease of assembly and disassembly without the need for tools. In other embodiments, the portable shower station does not have a base frame. In either design, either the base frame or the vertical tubes of the shower station will make contact with the ground or other surface forming the “floor” of the shower stall, the diameter of which can be referred to as a circumcircle diameter. The portable shower stations provided herein will have a circumcircle diameter of between about 50 in. to about 70 in., e.g., 50 in., 51 in., 52 in., 53 in., 54 in., 55 in., 56 in., 57 in., 58 in., 59 in., 60 in., 61 in., 62 in., 63 in., 64 in., 65 in., 66 in., 67 in., 68 in., 69 in., or 70 in. In a preferred embodiment, the portable shower stations provided herein will have a circumcircle diameter of between about 60 in. to about 65 in. (i.e., at least about 5 feet).

Rather than include one or more showerheads or hand showers, the 360-degree spray coverage of the instant portable shower stations is achieved by populating the vertical tubes that form the frame of the shower stall with spray nozzles. Suitable spray nozzles includes, but are not limited to spray nozzles providing a spray cone coverage of at least about 60 degrees, e.g., 60, 65, 70, 76, 80, 85, 90, 95, or more degrees. In a preferred embodiment, the spray nozzles provide a spray cone of coverage in the range from about 60 degrees to about 90 degrees. Each vertical tube may comprise at least one art-standard spray nozzle positioned along its length. Other embodiments will include more than one spray nozzle per vertical tube, e.g., 2, 3, 4, 5, 6, 7, 8, 9, 10, or more spray nozzles. Suitable spray nozzles may include full cone spray nozzles made from plastic (e.g., polyvinylidene fluoride, polyoxymethylene (POM), chlorinated polyvinyl chloride (CPVC), or similar plastic material), steel, stainless steel, and the like. Each spray nozzle may be positioned along the vertical tube to provide sufficient spray coverage without causing a significant reduction in pressure. As such, it is preferred to use only three or four spray nozzles per vertical tube.

For instance, in one embodiment, three spray nozzles are included per vertical tube at heights of about 25 in. to about 30 in. (e.g., 25 in., 26 in., 27 in., 28 in., 29 in., or 20 in.), about 50 in. to about 60 in. (e.g., 50 in., 51 in., 52 in., 53 in., 54 in., 55 in., 56 in., 57 in., 58 in., 59 in., or 60 in.), and about 70 in. to about 80 in. (e.g., 70 in., 71 in., 72 in., 73 in., 74 in., 75 in., 76 in., 77 in., 78 in., 79 in., or 80 in.) from the floor or base frame. For instance, in one particular embodiment, the three spray nozzles are positioned at heights of about 28 in., about 55 in., and about 76 in. from the base frame (see FIG. 1), or about 26¾ in., about 54 5/16 in., and about 75 5/16 in. from the base frame (see FIG. 6). In other embodiments, four spray nozzles will be positioned along the length of each vertical tube at heights of about 15 in. to about 25 in. (e.g., 15 in., 16 in., 17 in., 18 in., 19 in., 20 in., 21 in., 22 in., 23 in., 24 in., or 25 in.), about 30 in. to about 40 in. (e.g., 30 in., 31 in., 32 in., 33 in., 34 in., 35 in., 36 in., 37 in., 38 in., 39 in., or 40 in.), about 55 in. to about 65 in. (e.g., 55 in., 56 in., 57 in., 58 in., 59 in., 60 in., 61 in., 62 in., 63 in., 64 in., or 65 in.), and about 80 in. to about 90 in. (e.g., 80 in., 81 in., 82 in., 83 in., 84 in., 85 in., 86 in., 87 in., 88 in., 89 in., or 90 in.). For instance, in one particular embodiment, the four spray nozzles are positioned at heights of about 19 in., about 35 in., about 63 in., and about 86 in. from the ground or surface upon which the portable shower station is assembled (see FIG. 8).

The orientation or positioning of the spray nozzle may also depend on whether it is integrated into the lower tube section or the upper tube section. In general, the spray nozzles on the lower tube section will be positioned below the elbow joint or bend and be oriented in a substantially lateral orientation to provide a cone of spay that is substantially perpendicular to the flow of water through the lower tube section on which they are positioned. The spray nozzles on the upper tube section are typically positioned above the elbow joint or bend. The spray nozzles on the upper tube section can also be oriented in a substantially lateral orientation relative to the upper tube section to provide a cone of spray that is substantially perpendicular to the flow of water through the upper tube section on which they are positioned. However, due to the elbow joint or bend, the cone of spray will be angled downwards relative to the vertical axis of the shower stall. In some embodiments, the spray nozzles on the upper tube section (e.g., the upper most spray nozzles) can be oriented such that the cone of spray is at a slightly downward angle relative to the flow of water through the upper tube section (see, for example, FIG. 8). Therefore, the portable shower stations provided herein flow water from an external supply through the vertical tubes and top frame to provide 360-degree spray coverage of water within the shower stall.

As noted above, the portable shower stations disclosed herein will have at least one water supply inlet for connection to an external supply of water under pressure. In one embodiment, the water supply inlet is a garden house threaded inlet for connection to an art standard hose. However, as one have ordinary skill in the art will appreciate, the portable shower station of the instant invention can be designed with any art-standard water supply inlet adaptor depending on what is desired or customary in the surrounding geographic region, such as, but not limited to European air coupling, forestry coupling, quick connect garden hose couplings, and the like.

In one embodiment, the portable shower station can be disassembled into a plurality of components for ease of transport and storage. Once the disassembled portable shower station is brought to the location where decontamination is needed, the components are assembled to form the shower stall and connected to an external source of water under pressure. The vertical tube sections and top frame of this particular embodiment can be connected via a series of nonthreaded hose couplings that can be quickly coupled by the user. In this manner, assembly can be achieved without having to thread the components and without the need for tools. A hose coupling is a connector at the end of a hose, pipe, or tube for coupling to the end of another hose, pipe, or tube. Suitable hose couplings are constructed of steel, brass, stainless steel, aluminum, or plastic. Nonthreaded type hose couplings include, but are not limited to, cam and groove (camlock), Perrot Cardan coupling, British Instantaneous coupling, hozelock, leverlock, machino, transwagen flange couplings, quick-connected garden hose couplings, air king, Barcelona, DSP, European air coupling, express coupling, forestry coupling, Geka stream hose coupling, GOST, Guillemin symmetrical clutch, hoselink, Nakajima, tri-clamp connection, and ISC International Shore. In some embodiments, the tube sections are connected using other means, such as restriction fitting or spring-based locking mechanisms (e.g., push button spring locking pin or spring loaded pin). In a preferred embodiment, the vertical tube sections and top frame of the portable shower station are assembled using cam and groove hose couplings. For instance, each of the lower tube sections is coupled to a counterpart upper tube section, which, in turn, is coupled to the top frame by cam and groove couplings thereby forming the assembled shower stall.

The portable shower station may also include a base frame that is connected to the lower tube sections using the same or different coupling mechanism used to connect the other portions of the portable shower station, such as the cam and groove coupling. In a preferred embodiment, however, the base frame is connected to the lower tube sections using push button spring locking pins or spring loaded pins. Push button spring locking pins (also called snap button pins) are typically made from metal, such as steel, and are spring loaded. Similarly, spring loaded pin mechanisms are made from metal and incorporate a biasing spring to bias the pin in a locking position, which can be unlocked by applying force to move the pin against the spring. In one embodiment, a double end snap or push button spring locking pin is used to assemble each base segment to the counterpart lower tube section to form the base frame of the portable shower station. Alternatively, the base frame is connected to the lower tube sections using spring loaded pins.

In this manner, the portable shower station can be stored or transported as separate parts (e.g., angled vertical tubes, top frame, and bottom frame or upper tube sections, lower tube sections, base frame sections, and top frame). The portable shower station may comprise 4, 5, 6, 7, 8, 9, 10, 11, 12, or more parts for transport and storage. In some aspects, the quick assembly portable shower station comprises four parts (3 angled vertical tubes and a top frame) or five parts (3 angled vertical tubes, a top frame, and a base frame). In a preferred embodiment, such as the embodiment shown in FIGS. 1-3 and 6, the quick assembly portable shower station comprises ten parts (3 base frame tube sections, 3 lower tube sections, 3 upper tube sections, and a top frame, each of which capable of rapid assembly with hose couplings or snap pin/spring loaded pin connections). The portable shower station can be quickly assembled by coupling the lower tube sections to the corresponding upper tube sections to form the vertical tubes, coupling the vertical tubes to the top frame, and connecting the base frame sections to the vertical tubes to form the base frame. A hose, such as a garden house, is connected to an inlet on one of the vertical tubes so that the portable shower station is in fluid communication with an external source of water under pressure. The portable shower station will also have a standard inlet valve, such as a ball valve, for enabling the pressurized water supply to flow through the tubes of the portable shower station.

An exemplary embodiment of a quick assembly portable shower station is depicted in FIGS. 1-3. The portable shower station 10 includes a multicomponent base frame 20 assembled from three base tube sections 22, three multicomponent angled vertical tubes 30, and a top frame 50 that, when fully assembled, forms a shower stall 12 having a tripod configuration. The multicomponent angled vertical tubes 30 have about a 22.5 degree bend or angle α slightly above mid-height to taper the top portion of the portable shower station 10. The tube components of this particular embodiment are made from 1¼ in. polyvinyl chloride (i.e., PVC pipe) to ensure sufficient rigidity of the tubing while maintaining a relative light weight for ease of transport and assembly. As one having ordinary skill in the art will appreciate, alternative designs can be made from other rigid plastics or stainless steel.

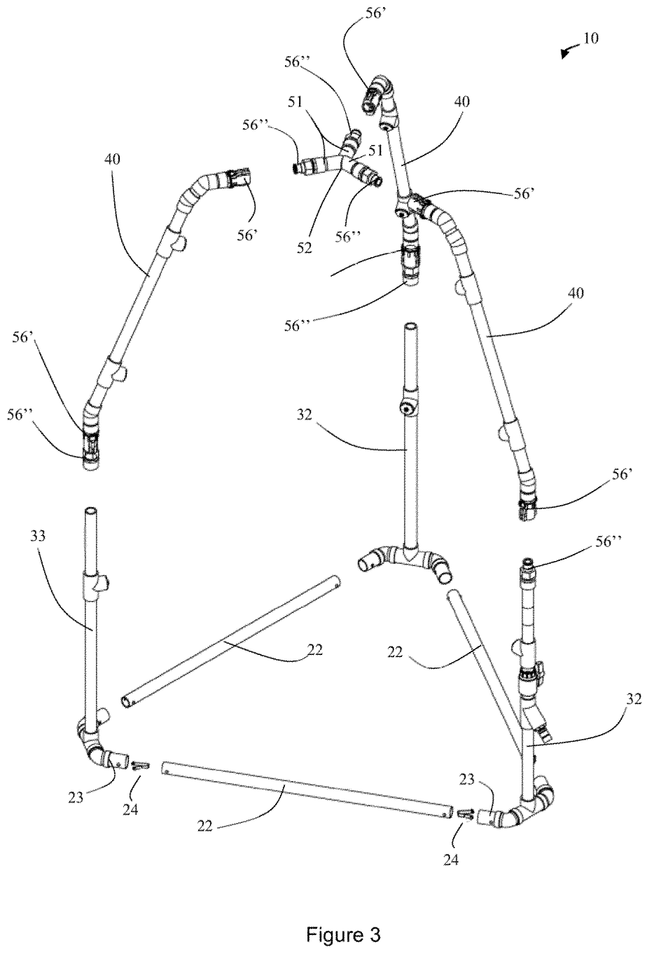

Each multicomponent angled vertical tube 30 includes a lower tube section 32, 33. In the embodiment shown in FIGS. 1 and 3, the lower tube section 33 of one of the multiple angled vertical tubes has a y-shaped tube 34 fluidly connected to a water supply inlet 35, such as, but not limited to, a garden hose thread adapter. The lower tube 33 additionally includes a valve member 36, such as a ball valve, in fluid communication with the water supply inlet 35 to enable the user to control the flow of water into the portable shower station 10 via the handle 37. At the bottom of each lower tube section 32, 33 is a tee-section 31, the lateral ends of which include elbow members 38, 38′. The elbow members 38, 38′ have an bend angle of about 60 degrees and are attached to the base connection adaptors 23 for connection to the base frame 20. In a preferred embodiment, the tee-sections 31 include an internal plug (not shown) for blocking the flow of water into the tee-section and to the multicomponent base frame 20. As such, the portable shower station 10 has a substantially dry multicomponent base frame 20, even when in operation.

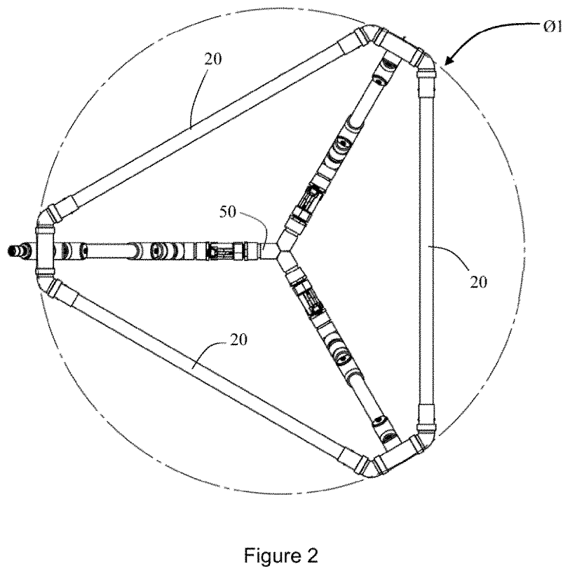

The multicomponent base frame 20 is assembled from three base tube sections 22. As best illustrated in FIG. 3, each of these base tube sections 22 are connected to a corresponding base connector adaptor 23 by way of a connection mechanism 24 that enables rapid assembly and disassembly. In the particular embodiment depicted in FIG. 3, the connection mechanism is a push button spring locking pin that allows the base tube sections 22 to be locked into the base connector adapters 23 to form the multicomponent base frame 20. As one having ordinary skill in the art will appreciate, the base tube sections 22 can be unlocked and disassembled from the base connector adapter by simply pressing the push button spring locking pin of the connection mechanism 24. The multicomponent base frame 20 generally has a triangular shape with a circumcircle diameter Ø1 of about 5 feet (see FIG. 2).

Each of the multicomponent angled vertical tubes 30 further includes an upper tube section 40 (see FIGS. 1 and 3). The upper tube section 40 shown in FIG. 1 includes two elbow sections 41, 41′ that have a bend angle of about 22.5 degrees, with one elbow section 41 positioned near the bottom of the upper tube section 40, and the other elbow section 41′ positioned towards the top of the upper tube section 40. The bottom elbow section 41 imparts the taper to the top half of the portable shower station 10 discussed above, whereas the top elbow section 41′ is immediately adjacent to another elbow section 42 that has a bend angle of about 45 degrees that, in cooperation with the top frame 50, forms the roof of the portable shower station 10. While the embodiment shown in FIG. 1 includes two adjacent elbow sections, the roof of the shower stall can be formed using one elbow section to provide the desired angle of bend. The top frame 50 is a y-shaped or WYE connector with three arm portions 51, each extending laterally from the center 52 at approximately 120-degree angles from each other. Thus, the multicomponent angled vertical tubes 30 form a tripod configuration. Although, as one having ordinary skill in the art will appreciate, the top frame can comprise arm portions that extend from the center at angles other than 120 degrees.

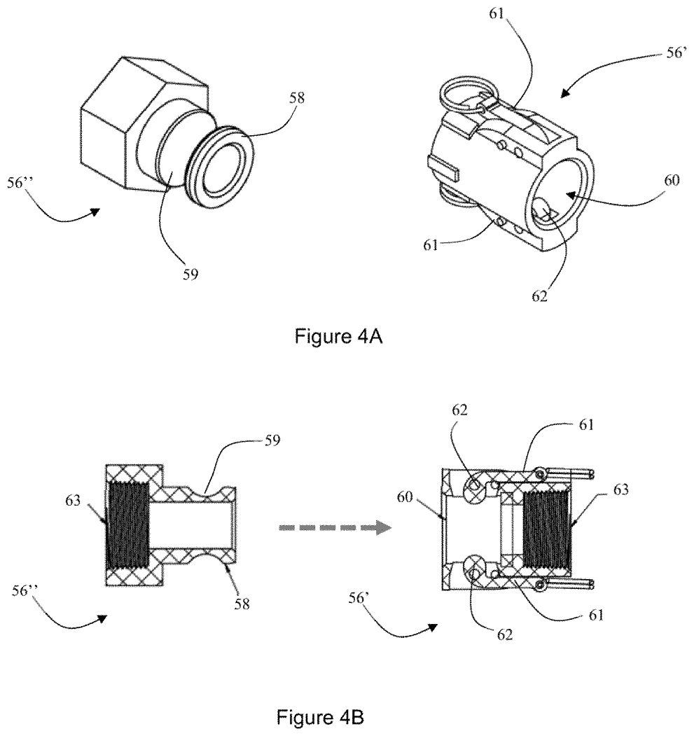

This particular embodiment is designed for quick assembly and disassembly to allow easy transport and storage. To accomplish this, the lower tube section 32, 33 of each multicomponent angled vertical tube 30 is connected to the corresponding upper tube section 40 by way of a hose coupling 56. Likewise, each upper tube section 40 is further connected to the top frame 50 via another hose coupling 56. The hose coupling 56 is a nonthreaded coupling designed to allow quick and easy assembly and disassembly of the top frame 50 and multicomponent angled vertical tubes 30. In this particular embodiment, the hose coupling 56 is a camlock or cam and groove type coupling (see, for example, FIGS. 3, 4A, and 4B).

The details of the hose coupling 56 is best depicted in FIGS. 4A and 4B. The hose coupling 56 comprises a groove portion 56″ and a groove coupling portion 56′. The groove portion 56″ has a mating member 58 that includes a circumferential groove 59 and a threaded bore 63 that is threadably attached to one tube (in this case, either the lower tube section 32 or the arm portion 51 of the top frame 50; see FIG. 3). The groove coupling portion 56′ has a threaded bore 63 that is threadably attached to the other tube to be coupled (in this case, either end of the upper tube section 40; see FIG. 3). The groove coupling portion 56′ includes two cam arms 61 and a receptacle 60 for receiving the mating member 58. The cam arms 61 of the groove coupling portion 56′ are pulled outwards which causes the locking element 62 to rotate away from the receptacle. The protrusion 58 of the groove portion 56″ is inserted into the receptacle 60 of the groove coupling portion 56′ and the cam arms 61 are moved back into their original position, which causes the locking elements 62 to rotate back into the receptacle 60 and into the circumferential groove 59 of the mating member 58 thereby locking the groove portion 56″ and groove coupling portion 56′ of the hose coupling 56 together. To dissemble, the cam arms 61 are again moved outward to unlock the groove portion 56″ from the groove coupling portion 56′. As such, the user can rapidly and easily assemble or disassemble the portable shower station components without needing specialized knowledge or tools.

The fully assembled portable shower station 10 is capable of a full 360-degree spray coverage due to the arrangement of the spray nozzles 70. Each spray nozzle 70 is attached to a tee-section 71 located at various points along the length of the multicomponent angled vertical tube 30. As shown in FIG. 1, each multicomponent angled vertical tube includes three spay nozzles 70 along its length. In particular, each lower tube section 32, 33 has one spray nozzle 70 in a substantially lateral spray orientation and positioned at a height of about 28 inches relative to the base frame 20. Each upper tube section 40 includes two spray nozzles 70 with spray orientations that are substantially perpendicular to the flow of water through the upper tube sections, but with which the spray cones angled slightly downward due to the bend angle of the upper tube section 40 (about 22.5 degrees at bottom elbow 41). The two spray nozzles 70 of the upper tube section 40 are positioned at heights of about 55 inches and about 76 inches, respectively, relative to the base frame 20.

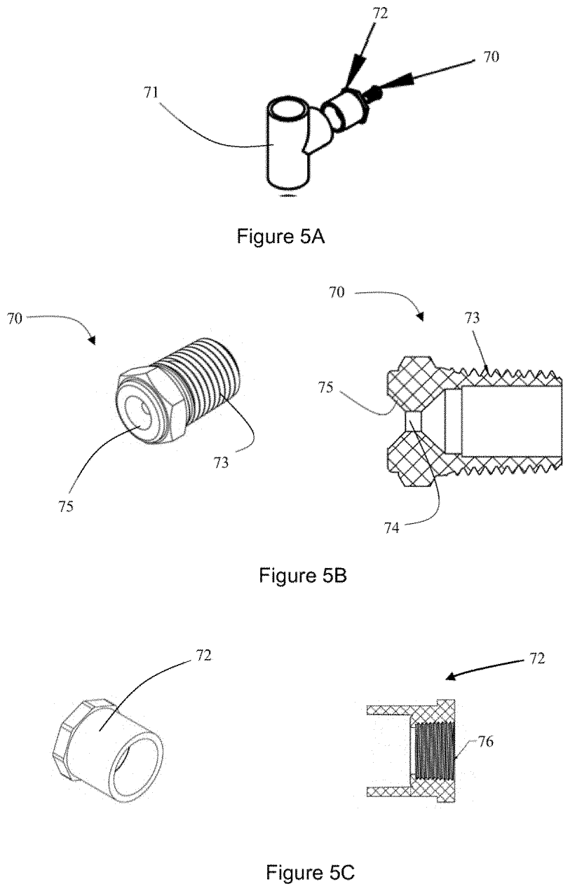

The particular spray nozzles 70 shown in FIGS. 1-3 are the preferred embodiment and are configured for an approximately 60-degree spray cone coverage, although any art-standard spray nozzles can be used with the invention (e.g., spray nozzles configured for 90-degree spray cone coverage). As shown in FIGS. 5A-5C, each spray nozzle 70 includes threading 73 for threadably attaching to the threaded bore 76 of the busing reducer 72, which, in turn, is attached to and in fluid communication with the tee section 71 of the multicomponent angled vertical tube 30. In operation, pressurized water passes through the throat 74 and outlet cone 75 of the spray nozzle 70 to produce the desired spray pattern.

In operation, the user attaches a source of pressurized water, such as a hose, to the water supply inlet 35. The user or other person in need of decontamination, such as a first line health care worker or emergency worker, enters into the shower stall 12, stands within the multicomponent base frame 20, and turns the handle 37 of the valve member 36 to the “on” possession to open the valve. The pressurized water then flows through the multicomponent angled vertical tube 30 into the top frame 50 and down the other the multicomponent angled vertical tubes 30. However, the plugs (not shown) in each of the tee-sections 31 of the lower tube sections 32, 33 prevent water from flowing through the multicomponent base frame 20 thus maintaining a substantially dry base. As the water flows through the multicomponent angled vertical tubes 30, portions of water exit each of the nine spray nozzles 70 as a 60-degree cone spray. The inner dimensions of the shower stall 12 and the angles of nine spray nozzles 70 provide a 360-degree spray coverage for a period of time sufficient for adequate decontamination. The shape of the multicomponent base member 20 and the tripod configuration of the portable shower stall 12 provide increased stability as compared to other portable showers existing in the art so as to keep the frame of the shower from tipping over under the pressure of the water flow. Once decontamination is complete, the user simply turns the handle 37 of the valve member 36 to the “off” position. The flow rates for the embodiment depicted in FIGS. 1-3 are summarized in Table 1.

TABLE 1
Flow Rate

| Psi | GPM |
|---|---|
| 10 | 5.4 |
| 40 | 10.8 |

Psi, pound force per square inch
GPM, gallons per minute

As shown in FIG. 3, the portable shower station 10 comes in ten sections that are easily disassembled and reassembled for ease of transport and storage. Each of the three lower tube sections 32 (or 33) can be quickly coupled to a counterpart upper tube section 40 by engaging the hose coupling 56 to assemble the three multicomponent angled vertical tubes 30. Similarly, the multicomponent angled vertical tubes 30 are connected to the top frame 50 by engaging the hose couplings 56 between the upper tube sections 40 and the arm portions 51 of the top frame 50. Finally, the lower tube sections 32, 33 can be connected to the base tube sections 22 by slipping each base tube section 22 over the appropriate push button spring locking pin 24 to form the multicomponent base frame 20. The assembled portable shower station 10 can be disassembled by disengaging the hose couplings 56 and the push button spring locking pins 24.

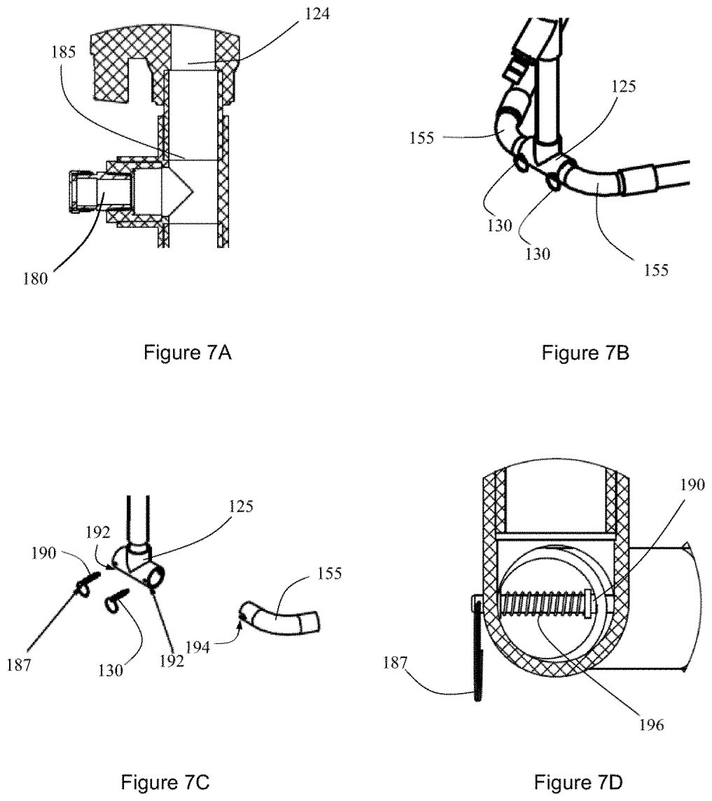

FIGS. 6 and 7 depict another embodiment of a quick assembly portable shower station that functions in a manner similar to the quick assembly portable shower station of FIGS. 1-3. As shown in FIG. 6, the quick assembly portable shower station 100 includes a multicomponent base frame 110 assembled from three base tube sections 115, three multicomponent angled vertical tubes 120, and a top frame 150 that, when fully assembled, forms a shower stall 105 having a tripod configuration. The multicomponent angled vertical tubes 120 have about a custom bent tube section having a 22.5 degree bend 160 slightly above mid-height to taper the top portion of the portable shower station 100. Each multicomponent angled vertical tube 120 will include an upper tube section 122 and a lower tube section 123, 124. Each upper tube section 122 can be rapidly connected to the top frame 150 and a lower tube section 123, 124 by way of the hose coupling 135 as explained in detail above. The upper tube sections 122 include a custom-bent elbow 165 having about a 45 degree bend just before the connection to the top frame 150 for forming the top of the shower stall 105. In this particular embodiment, the hose coupling 135 is a camlock or cam and groove type coupling. The camlock and groove type couplings are described in greater detail elsewhere herein.

As with the quick assembly portable shower station describe above, the multicomponent base frame 110 shown in FIG. 6 is substantially dry, even when in operation due to plugs in the lower tubes preventing the flow of water into the base frame. The multicomponent base frame 110 is assembled from three base tube sections 115, each of which connected to two tee sections 125 at the bottom of the lower tube sections 123 or 124. In this particular embodiment, each of the base tube sections 115 have a custom-bent piping section, or elbow 155, at either end that is bent at about a 60-degree angle and is enabled for quick attachment to the tee sections 125 via a spring loaded pin connection mechanism 130. The connection mechanism 130 is depicted in greater detail in FIGS. 7B-7D. Each connection mechanism 130 has a pull ring 187 and a pin 190. The pins 190 have a biasing spring 196 disposed around their length. In operation, the pins 190 are disposed through the pin holes 192 on either lateral end of the base of the tee section 125 and biased inwardly via the biasing springs 196 (i.e., in the locking position). For quick assembly, the user pulls on the pull ring 187, which moves the pin 190 through the pin hole 192 against the biasing spring 196 in an outwardly direction (i.e., to the unlocking position). This enables the insertion of the elbow 155 of the base tube section 115 into the opening of the tee section 125. The user then releases the pull ring 187, which causes the pin 190 to be moved through the pin hole 192 in an inwardly direction. As the pin 190 moves inward, it moves through the pin receptacle 194 of the elbow 160 thereby locking the base tube section 115 into place. This process can be quickly performed on each of the three base tube sections 115 to connect them to the corresponding tee sections 125 and assemble the multicomponent base frame 110. When assembled, the multicomponent base frame 110 generally has a triangular shape with a circumcircle diameter of about 5 feet.

The fully assembled quick assembly portable shower station 100 is capable of a full 360-degree spray coverage due to the arrangement of the spray nozzles 145. Each spray nozzle 145 is attached to a tee section 140 located at various points along the length of the multicomponent angled vertical tubes 120. As shown in FIG. 6, each multicomponent angled vertical tube 120 includes three spay nozzles 145 along its length. In particular, each lower tube section 124 has one spray nozzle 145 in a substantially lateral spray orientation and positioned at a height of about 26 to about 27 inches relative to the base frame 110 (the lower tube section 123 has one spray nozzle 145 positioned in a substantially lateral spray orientation and positioned at a height of about 27 to about 28 inches relative to the base frame 110). Each upper tube section 122 includes two spray nozzles 145 with spray orientations that are substantially perpendicular to the flow of water through the upper tube sections, but with which the spray cones angled slightly downward due to the bend angle of the upper tube section 122 (about 22.5 degrees at bottom elbow 160). The two spray nozzles 145 of the upper tube section 122 are positioned at heights of about 54 to about 56 inches and about 75 to about 76 inches, respectively, relative to the base frame 110. The spray nozzles 145 are configured for an approximately 60-degree spray cone coverage, although any art-standard spray nozzles can be used with the invention.

The operation of the quick assembly portable shower station 100 is described above in detail. In this embodiment, however, the lower tube section 124 includes both a water supply inlet 170 and an optional outlet 180 (see FIGS. 6 and 7A). The optional outlet 180 can be incorporated into the lower tube section via a tee section 185 or other similar piping. The water supply inlet 170 works in a manner similar to the embodiment depicted in FIGS. 1-3. The user attaches a source of pressurized water, such as a hose, to the water supply inlet 170. The user or other person in need of decontamination enters into the shower stall 105, stands within the multicomponent base frame 110, and turns the valve handle 175 to the “on” possession to open the valve. The pressurized water then flows through the multicomponent angled vertical tube 120 into the top frame 150 and down the other the multicomponent angled vertical tubes 120. The flow rates for this quick assembly portable shower station embodiment are shown in Table 2.

TABLE 2
Flow Rate

| Psi | GPM |
|---|---|
| 30 | 10.8 |

Psi, pound force per square inch
GPM, gallons per minute

When the optional outlet 180 is not in use, the outlet can be blocked with a plug. In a preferred embodiment, the optional outlet 180 is positioned between the valve handle 175 and the water supply inlet 170. The user can attach a secondary decontamination device, such as, but not limited to, an eyewash or spray hose to the optional outlet 180, each of which may contain its own valve or nozzle mechanism for controlling the flow of water into the eyewash or spray hose independently of the shower. The eyewash can be used for rapid decontamination or rinsing of the eyeballs. The spray hose may include a manually operated spray nozzle for targeted application of water to difficult to reach areas, such as, but not limited to the armpits, foot bottoms, crotch area, etc. In addition, the spray hose may incorporate a container filled with decontamination liquid that is mixed with the water as it flows out of the spray nozzle opening. In some embodiments, the decontamination liquid or foam may be suitable for decontaminating biological (e.g., anthrax spores) or chemical agents (e.g., chemical warfare agents, toxic industrial materials, radioactive materials).

The inner dimensions of the shower stall 105 and the angles of the nine spray nozzles 145 provide a 360-degree spray coverage for a period of time sufficient for adequate decontamination. The shape of the multicomponent base frame 110 and the tripod configuration of the portable shower stall 105 provide increased stability as compared to other portable showers existing in the art so as to keep the frame of the shower from tipping over under the pressure of the water flow.

In the disassembled configuration, the quick assembly portable shower 100 station shown in FIGS. 6 and 7 is in ten parts—the top frame 150, three upper tube sections 122, three lower tube sections 123, 124, and three base tube sections 115. The user can assemble the components in any order, for example, the user can connect the upper tube sections 122 to the lower tube sections 123, 124 via the cam and groove hose couplings 135 to form the multicomponent angled vertical tubes 120 in a manner similar to what is described above. The user connects the upper tube sections 122 to the top frame 150 via the cam and groove hose couplings 135 to form the top of the shower stall, and then connects the base tube sections 115 to the tee sections 125 of the lower tube sections 123, 124 via the connection mechanisms 130 to complete the assembly. Finally, the user connects a hose or other supply of water under pressure to the water supply inlet 170. The water supply will flow through the multicomponent angled vertical tubes 120 and top frame 150 when the user turns the valve handle 175 to the “on” possession to open the valve. For disassembly, the user disconnects each of the above-described valve components via the cam and groove hose couplings 135 and the connection mechanisms 130. The quick assembly portable shower 100 components can then be easily transported or stored in, for example, a bag or craft box.

In another embodiment, the portable shower station is not stored and/or shipped as separate components, but rather includes a combination of hinge members and hose couplings between the vertical tube sections and the top frame to enable the user to fold or collapse the portable shower station for transport and storage. In a preferred embodiment, the collapsible portable shower station has a tripod configuration when extended for use and does not include a base frame. Rather, the vertical tubes include flanges at their base for anchoring to the ground or other surface. Each vertical tube will include a lower tube section and an upper tube section connected by a hinge member so that the tube sections can be folded together. The hinge members will preferably be hinges that move in both a rotational direction and an axial direction so that the vertical tube sections can be folded or collapsed and then moved axially to enable coupling of the hose couplings to seal and lock the tube sections. Suitable hinge members are available in the art and included, but are not limited to, plate hinges and pivot hinges. When extended, the lower tube section is coupled to the upper tube section by a hose coupling as discussed above to impart stability to the structure when in operation and to prevent leakage of pressurized water from the connection.

FIGS. 8-11 depict the tripod-type portable shower station 200 capable of being folded or collapsed for storage and transport. The components of this particular embodiment are made from 1 inch or 1¼ inch stainless steel pipe, although other construction materials may be suitable, such as PVC or other rigid plastics. The portable shower station 200 includes three multicomponent angled vertical tubes 210 and a top frame 240 for flowing water from a pressurized water supply to a plurality of spray nozzles 280. The multicomponent angled vertical tubes 210 and top frame 240 cooperate to form the shower stall 205. A total of twelve spray nozzles 280, each of which is capable of spraying pressurized water in a 60-degree cone spray pattern, provide a coordinated 360-degree spray coverage to a user when that user is within the shower stall 205.

Each multicomponent angled vertical tube 210 is comprised of an upper tube section 230 and a lower tube section 220, 221. Each lower tube section 220, 221 has an anchoring flange 250 at the bottom end to enable the user to anchor the portable shower station 200 to the ground and stabilize the structure. The anchoring flanges 250 typically include a flange ear 252 and one or more anchoring holes 251 through which nails, stakes, bolts and the like can be used to secure the portable shower station 200 to the ground.

Near the top end of each lower tube section 220, 221 is an elbow joint 225 that produces a bend angle of about 25 degrees from vertical. One of the lower tube sections 221 includes the water supply inlet 222 (e.g., with a garden hose thread) and an inlet valve 223, which is typically a ball valve. In some versions of the portable shower station 200, one or more of the spray nozzles 280, such as the lower spray nozzle on the lower tube section 221, can be replaced with an outlet 290 for fluid communication with a secondary decontamination device, such as, but not limited to, a portable eyewash station or spray hose (not shown). On this version of the portable shower station 200, the outlet 290 can be closed with a plug 291 when not connected to the secondary decontamination device. Suitable plugs include, but are not limited to, rubber stoppers or threaded plugs (e.g., according to national pipe thread standards). In some embodiments, the outlet 290 is positioned below the inlet valve 223, but above the water supply inlet 222, and will be controlled by a separate valve located on an eyewash to allow the user to operate the eyewash independently of the shower. In other embodiments, a spray hose is connected to the outlet 290 and is operated by manually squeezing the spray nozzle, which enables the user to operate the spray hose independently of the shower. As one having ordinary skill in the art would appreciate, certain embodiments of a spray hose attachment may incorporate a separate container with decontamination fluid that is mixed with the water near the spray nozzle outlet.

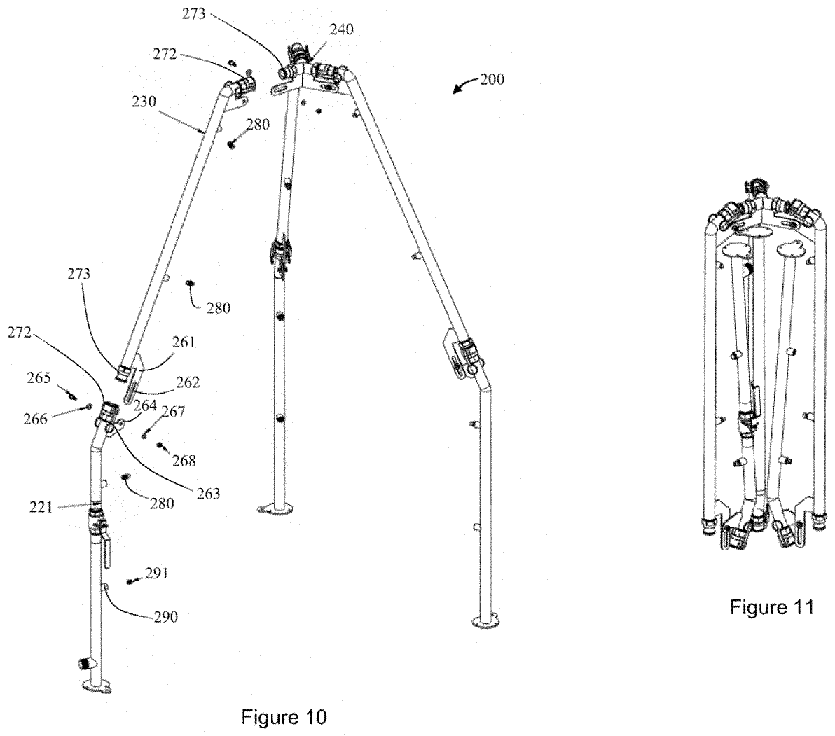

Each lower tube section 220, 221 is attached to a counterpart upper tube section 230 by a welded plate hinge 260 as shown in FIGS. 8 and 10. The welded plate hinge 260 typically is formed from two plates—a top plate 261 that is welded or otherwise attached to the upper tube section 230 and a bottom plate 263 that is welded or otherwise attached to the lower tube section 220, 221 (see, for example, FIG. 10). The top plate 261 has a slot opening 262 that is aligned with the hole 264 in the bottom plate 263. A shoulder screw 265 is inserted through the hole 264 in the bottom plate 263 and slot opening 262 of the top plate 261 and fastened to a locknut 268. General purpose washers 266, 267 are shown in the welded plate hinge 260 assembly. In this manner, the shoulder screw 265 slides along the slot opening 262 as the welded plate hinge 260 enables the lower tube section 220, 221 to be folded inward in relation to the upper tube section 230. Alternatively, other plate hinge designs can be used, such as a pivot hinge. In addition, the lower tube section 220, 221, can be coupled to the upper tube section 230 by a hose coupling 270 when in the extended position. The preferred hose coupling 270 is a cam and groove type coupling with the groove portion 273 attached to the upper tube section 230 and the groove coupling portion 272 attached to the lower tube section 220, 221 (see FIG. 10). The welded plate hinges 260 have both rotational movement and axial movement to enable the user to extend the tube sections and lock them into place via the hose couplings 270. The coupling and uncoupling of the cam and groove type coupling is described in detail above.

The upper tube sections 230 are further attached to the top frame 240 with a welded plate hinge 269, which may be the same as the plate hinge 260 used to attach the lower tube sections 220, 221 and upper tube sections 230, or may have larger plates welded at different angles if required by the design specifications. Alternatively, the upper tube sections 230 can be attached to the top frame 240 using pivot hinges or other suitable hinges existing in the art. Near the top of each upper tube section 230 is an elbow joint having a bend angle of about 100 to about 120 degrees (preferably, about 115 degrees) to form part of the roof of the shower stall 205. As shown in FIG. 8, the top frame 240 is a y-shaped tube with three arm portions 241 laterally extending from a center 242 at about 120 degree angles from each other to provide attachment points for each of the three multicomponent angled vertical tubes 210. As such, the top frame 240 and the three multicomponent angled vertical tubes 210 form a tripod configuration when in operation. As with the upper and lower leg connections, the upper tube sections 230 can be coupled to the corresponding arm portion 241 of the top frame 240 with hose couplings 270, the function of which is explained in detail above.

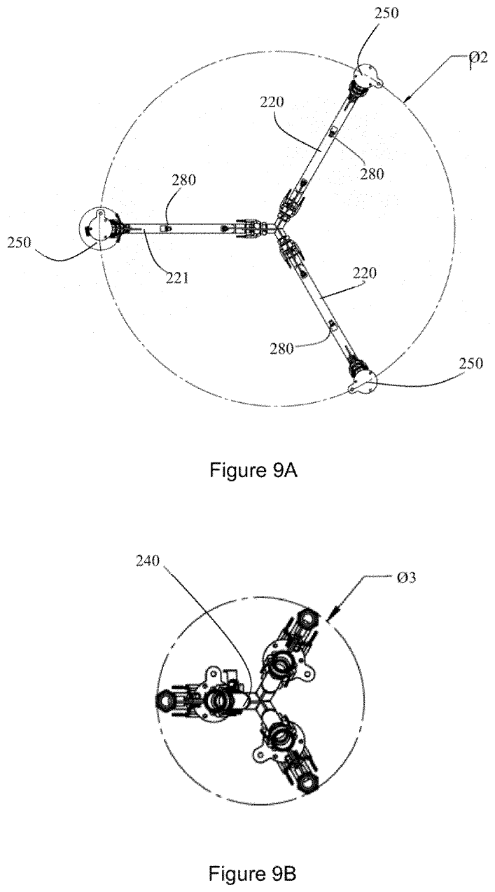

When fully extended, coupled, and secured to the ground, the portable shower station 200 has a tripod structure that is tapered at the top portion of the shower stall 205. The circumcircle diameter measured at the bottom of the shower stall is about 62 to about 65 inches (see FIG. 9A). As noted above, the lower tube sections 220, 221 each have a bend angle of about 25 degrees producing the tapered dimensions of the portable shower station 200. As a result the, circumcircle diameter of the top of the shower stall is about 20 to about 22 inches (see FIG. 9B). In the embodiment shown in FIGS. 8 and 9, the shower stall 205 has a height of about 90 inches. Each of the multicomponent angled vertical tubes 210 includes four spray nozzles 270. On each of the lower tube sections 220, 221 are two spray nozzles 270, each in a substantially lateral orientation (i.e., perpendicular to the lower tube section) and positioned at heights of about 19 inches and 35 inches, respectively. On each of the upper tube sections 230 are two spray nozzles 280 positioned at heights of about 63 inches and 86 inches, respectively. The lower spray nozzle 280 is in a substantially lateral orientation relative to the upper tube section (i.e., perpendicular to the upper tube section). Due to the tapered structure, the lower spray nozzle 280 produces a spray of water in a downward angle. The upper spray nozzle 280 is oriented at about a 35 degree angle relative to the upper tube section 230, which produces a highest spray intersection at centerline of about 83 inches. As such, the portable shower station 200 produces a 360-degree spray coverage for the vast majority of user body types. It being understood, however, that the spray nozzle positioning and orientation shown in FIGS. 8-11 represent one exemplary, preferred embodiment to maximize spray coverage while using a minimal number of spray nozzles, but that alternative spray nozzle positioning and orientation are contemplated without departing from the crux of the invention.

In operation, the user will extend the upper tube sections 230 and lower tube sections 220, 221, and couple each of the sections using the hose couplings 270 to lock the upper tube sections 230 and lower tube sections 220, 221 into position forming the tripod configuration. The bend angle of the lower tube sections 220, 221 create a tapered top portion of the shower stall 205. The user will then anchor the portable shower station 200 to the ground by hammering stakes or bolts through the anchoring holes 251 and into the ground. For surfaces where using bolts or stakes is not practical (e.g., steel or concrete floors and other surfaces), heavy sandbags or other weighted objects can be placed over the anchoring flanges 250 and flange ears 252 to stabilize the portable shower station 200.

The user will then use a hose that is fluidly connected to an external supply of water under pressure and attach the hose to the water supply inlet 222. As noted above, the exemplary portable shower station 200 includes a GHT type water supply inlet. However, as one have ordinary skill in the art will appreciate, the portable shower station of the instant invention can be designed with any art-standard inlet adaptor depending on what is desired to is customary in the surrounding geographic region. Once the portable shower station 200 is fluidly connected to the external pressurized water supply, the user steps into the shower stall 205 and turns the handle 224 of the inlet valve 223 to the “on” position. The flow rates for the embodiment depicted in FIGS. 8-11 are summarized in Table 3.

TABLE 3
Flow Rate

| Psi | GPM |
|---|---|
| 20 | 25 |
| 40 | 36 |
| 100 | 55 |

Psi, pound force per square inch
GPM, gallons per minute

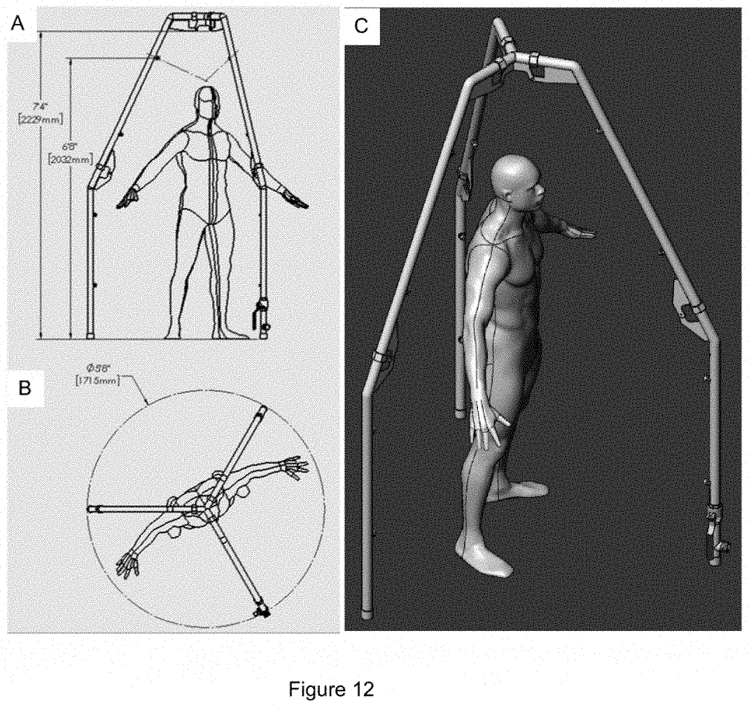

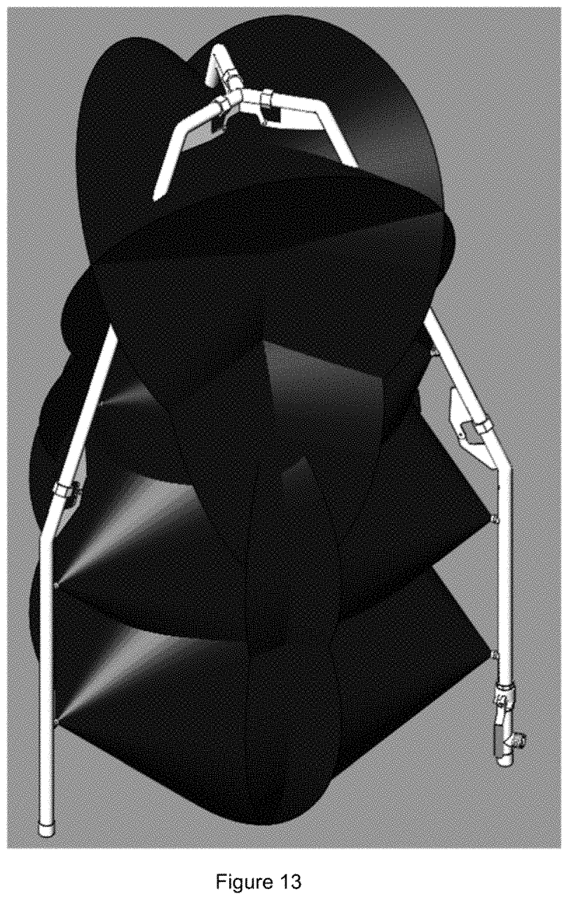

FIG. 12 depicts an individual standing in the shower stall that has a vertical clearance of over 7 feet. The pressurized water will flow through the lower tube section 221, up the corresponding upper tube section 230, through the top frame 240, and through the other two multicomponent angled vertical tubes 210. As the pressurized water flows through the multicomponent angled vertical tubes 210, the pressurized water will exit the spray nozzles 280 to provide the 360-degree spray coverage to the user (see FIG. 13).

Once decontamination is complete, the handle 224 is turned to the “off” position. The portable shower station 200 can then be folded up or collapsed by uncoupling the hose couplings 270 as discussed above and folding the legs up as shown in FIG. 11. The portable shower station 200 in the collapsed or folded configuration is about 4 feet, 5 inches long and about 2 feet wide and can be stored and transported in conventional bags or boxes, such as a bounding box.

The portable shower stations described herein can be transported to and rapidly assembled to any sight where individuals are in need of decontamination of hazardous substances, such as radiation, chemicals, and biological hazards, so long as there is a nearby external source of water under pressure. The external source of water can be from a home, office building, factory, hospital, research laboratory, fire hydrant, water tank, fire truck, or other facility or water storage structure where a hose or other water conveyance device is run from the source of water and connected to the portable shower station as described above. The portable shower stations described herein can be used by firefighters, researchers, doctors, hazmat personnel, and other first responders at the scene of a biological spill, radiation leak, chemical spill, laboratory accident, or other situation where such individuals are exposed to hazardous substances thus requiring the need for decontamination.

The 360-degree spray coverage allows for efficient decontamination. The individual in need of decontamination is exposed to the 360-degree decontamination spray within the shower stall for a period of time sufficient for adequate decontamination. As one having ordinary skill in the art will appreciate, the period of time for decontamination with the present invention will depend on the type and amount of decontaminate present on the individual's person, as well as the decontamination procedures for a given site or applicable government regulation. Nevertheless, the increased efficiency of the present system allows for shorter decontamination times, if desired or in compliance with applicable regulations/standard safety procedures, as compared to other portable shower stations existing in the art. For instance, in one embodiment, the individual is exposed to the decontamination spray for a period of time of at least about 5 seconds, e.g., 5 s, 10 s, 15 s, 20 s, 25 s, 30 s, 35 s, 40 s, 45 s, 50 s, 55 s, 1 m, 2 m, 3 m, 4 m, 5 m, 6 m, 7 m, 8 m, 9 m, 10 m, 11 m, 12 m, 13 m, 14 m, 15 m, 16 m, 17 m, 18 m, 19 m, 20 m, 25 m, 30 m, 35 m, 40 m, 45 m, 50 m, 55 m, 1 h. In many cases, recommended decontamination times are for at least about 30 seconds; preferably, at least about 1 minute; more preferably, at least about 10 minutes. For some cases, the period of time needed for decontamination ranges from about 30 seconds to about 30 minutes; or less than about 20 minutes, or less than about 15 minutes. In some embodiments, a specially formulated decontamination liquid instead of water can be flowed through the portable shower stations for decontamination.

### Reference Numbers

10—portable shower station
12—shower stall
20—multicomponent base frame
22—base tube sections
23—base connection adaptors
24—connection mechanism (push button spring locking pin)
30—multicomponent angled vertical tube
31—tee section (for base connection)
32—lower tube section
33—lower tube section with inlet
34—y-shaped inlet tube
35—water supply inlet (GHT)
36—valve member
37—handle
38—elbow (60 degrees)
38′—elbow (60 degrees)
40—upper tube section
41—elbow section (22.5 degrees)
41′—elbow section (22.5 degrees)
42—elbow section (45 degrees)
50—top frame (WYE connector)
51—arm portion
52—center
56—hose coupling (cam-lock)
56′—groove coupling portion (with locking arms)
56″—groove portion
58—mating member
59—circumferential groove
60—receptacle
61—cam arms
62—locking elements
63—threaded bore
70—spray nozzle
71—tee section (for spray nozzle)
72—bushing reducer
73—threading
74—throat
75—outlet cone
76—threaded bore
100—portable shower station
105—shower stall
110—multicomponent base frame
115—base tube sections
120—multicomponent angled vertical tube
122—upper tube section
123—lower tube section
124—lower tube section with inlet
125—tee section (for base connection)
130—connection mechanism (spring loaded pin)
135—hose coupling
140—tee section (for spray nozzle)
145—spray nozzle
150—top frame
155—elbow (60 degrees)
160—elbow (22.5 degrees)
165—elbow (45 degrees)
170—water supply inlet (GHT)
175—valve handle
180—optional outlet (eyewash or spray hose)
185—tee section (optional outlet)
187—pull ring
190—pin
192—pin hole
194—pin receptacle
196—biasing spring
200—portable shower station
205—shower stall
210—multicomponent angled vertical tube
220—lower tube section
221—lower tube section with inlet
222—water supply inlet
223—inlet valve
224—handle
225—elbow joint (25 degrees)
230—upper tube section
231—elbow joint (95-100 degrees)
240—top frame
241—arm portion
242—center
250—anchoring flanges
251—anchoring holes
252—flange ear
260—plate hinges
261—top plate
262—top plate slot opening
263—bottom plate
264—bottom plate opening
265—shoulder screw
266—washer
267—washer
268—locknut
269—plate hinge (top)
270—hose couplings
272—groove coupling portion (with locking arms)
273—groove portion
280—spray nozzles
290—optional outlet (eyewash or spray hose)
291—plug for optional outlet

The following examples are provided to describe the invention in greater detail. They are intended to illustrate, not to limit, the invention.

1. A portable shower station for connection to a supply of water under pressure, the shower station comprising:
a base frame;
a top frame;
a plurality of angled vertical tubes, wherein:
(i) each angled vertical tube is connected to and upstanding from the base frame, wherein each angled vertical tube is connected to the base frame by a first connection member; and
(ii) each angled vertical tube is connected to the top frame by a second connection member; and
a water supply inlet on at least one of the angled vertical tubes for connecting the portable shower station to a supply of water under pressure, and a valve member for enabling the flow of water through the angled vertical tubes and the top frame, whereby the angled vertical tubes and the top frame cooperatively define a shower stall; and
wherein each angled vertical tube comprises at least one spray nozzle for spraying a portion of the water into the shower stall.

2. The portable shower station of claim 1, wherein each angled vertical tube is a multicomponent angled vertical tube comprising a lower tube section that is connected to the base frame by the first connection member and an upper tube section that is connected to the top frame by the second connection member, wherein each upper tube section comprises a lower end that is vertically connected to an upper end of the lower tube section by a third connection member.

3. The portable shower station of claim 1, comprising at least three angled vertical tubes.

4. (canceled)

5. The portable shower station of claim 1, wherein each angled vertical tube comprises at least three spray nozzles for spraying a portion of the water in the shower stall, wherein each spray nozzle provides a spray cone coverage of at least about 60 degrees, and wherein the spray nozzles cooperatively provide a total spray coverage of about 360 degrees.

6. The portable shower station of claim 1, wherein the base frame is a multicomponent base frame comprising a plurality of base tube sections, each of which is connected to two of the angled vertical tubes by the first connection members.

7. (canceled)

8. The portable shower station of claim 1, any one of claims 1 7, wherein each of the second connection members is a hose coupling enabling connection and disconnection of the angled vertical tubes from the top frame and base frame.

9. The portable shower station of claim 2, wherein each of the third connection members is a hose coupling enabling connection and disconnection of the upper tube section and lower tube section of each multicomponent angled vertical tube.

10. The portable shower station of claim 1, wherein the base frame has a circumcircle diameter of at least about 5 feet, and wherein the shower stall has a height of at least about 7 feet.

11. (canceled)

12. The portable shower station of claim 1, wherein each angled vertical tube comprises along its length at least one bend angle at least about 20 degrees such that the top of the shower stall is tapered relative to the bottom of the shower stall.

13. The portable shower station of claim 1, wherein the first connection member is a button spring locking pin or a spring loaded pin.

14. (canceled)

15. (canceled)

16. The portable shower station of claim 1, wherein each of the angled vertical tubes, top frame, and base frame comprises polyvinyl chloride with a total weight of less than about 30 pounds.

17. (canceled)

18. The portable shower station of claim 1, wherein one of the angled vertical tubes further comprises an outlet on one of the lower tube sections for connection to a second decontamination device.

19. The portable shower station of claim 18, wherein the second decontamination device is an eyewash or spray hose.

20. A portable shower station comprising
(a) a multicomponent base frame comprising a plurality of base tube sections, wherein each base tube section comprises a first connection member at each end;
(b) a top frame comprising a plurality of arm portions extending laterally from a central point, wherein each arm portion comprises a first portion of a hose coupling;
(c) three multicomponent angled vertical tubes, wherein each of the multicomponent angled vertical tubes comprises:
(i) at least one spray nozzle;
(ii) an upper tube section comprising a top end comprising a second portion of a hose coupling, and a bottom end comprising a third portion of a hose coupling; and
(iii) a lower tube section comprising a top end comprising a fourth portion of a hose coupling, and a bottom end comprising two second connection members; and
wherein one of the plurality of multicomponent vertical tubes comprises an inlet valve and water supply inlet for connecting the portable shower station to a supply of water under pressure;
wherein water flows through the multicomponent angled vertical tubes and the top frame when in an assembled configuration and when the water supply inlet is connected to the supply of water under pressure, the assembled configuration comprising:
a) the first portion of the hose coupling of each arm portion of the top frame is coupled to the second portion of the hose coupling of an upper tube section;
b) the third portion of the hose coupling of each upper tube section is coupled to the fourth portion of the hose coupling of a lower tube section; and
c) the first connection members of each base tube section is connected to a second connection element of a lower tube section, wherein the lower tube sections, the upper tube sections, the top frame, and the base tube sections form a shower stall.

21. The portable shower station of claim 20, wherein each multicomponent angled vertical tubes comprises three spray nozzles configured to spray a portion of the water under pressure into the shower stall when the water supply inlet is connected to the supply of water under pressure.

22. (canceled)

23. The portable shower station of claim 20, wherein each multicomponent angled vertical tube comprises an elbow having a bend angle of about 15 degrees to about 30 degrees.

24. The portable shower station of claim 20, wherein the hose coupling is a cam and groove hose coupling, and wherein the first connection member and the connection member are connected by a push button spring locking pin or a spring loaded pin.

25. (canceled)

26. The portable shower station of claim 20, further connected to a source of water under pressure.

27. The portable shower station of claim 20 any one of claims 20 26, wherein one of the multicomponent angled vertical tubes further comprises an outlet on one of the lower tube sections for connection to an eyewash station or a spray hose.

28. (canceled)

29. A method of decontaminating an individual in need thereof, comprising:
a) providing an individual in need of decontamination;
b) providing the portable shower station of claim 20;
c) assembling the portable shower station, wherein the assembling comprises coupling the first portion of the hose coupling of each arm portion of the top frame to the second portion of the hose coupling of an upper tube section, coupling the third portion of the hose coupling of each upper tube section to the fourth portion of the hose coupling of a lower tube section, and connecting each first connection element of each base tube section to a second connection element on a lower tube section, and wherein the assembled portable shower station comprises a shower stall;
d) connecting the water supply inlet to an external source of water under pressure; and
e) opening the inlet valve whereby the water under pressure flows through each of the lower tube sections, the upper tube sections, and the top frame, and exits the plurality of spray nozzles to produce a decontamination water spray to the individual when the individual is within the shower stall.

30-40. (canceled)

41. The method of claim 29, wherein the individual in need of decontamination is exposed to the decontamination water spray for a period of time of between of at least about 30 seconds.

42. The method of claim 29, wherein the individual in need of decontamination has been exposed to a hazardous substance selected from the group consisting of a chemical, biological contaminate, radioactive substance, and any combination thereof.

43. The method of claim 29, comprising the step of disassembling the portable shower station.

44. The method of claim 43, wherein the step of disassembling comprises uncoupling the hose couplings and disconnecting the first and second connection elements.

45-67. (canceled)
